(19) United States
(12) Patent Application Publication
(10) Pub. No.: US 2022/0300880 A1
(43) Pub. Date: Sep. 22, 2022

(54) ROUTING OF FLUID PIPELINES

(71) Applicant: SOURCEWATER, INC., Houston, TX (US)

(72) Inventor: Joshua ADLER, Houston, TX (US)

(21) Appl. No.: 17/665,098

(22) Filed: Feb. 4, 2022

Related U.S. Application Data
(63) Continuation of application No. 16/935,779, filed on Jul. 22, 2020, now abandoned.
(60) Provisional application No. 62/877,436, filed on Jul. 23, 2019.

(51) Int. Cl. G06Q 10/06; G06F 3/0486; G06Q 30/00; G06Q 10/04; G06Q 50/06; G06Q 50/08

(52) U.S. Cl. CPC G06Q 10/06313; G06F 3/0486; G06Q 30/018; G06Q 10/047; G06Q 50/06; G06Q 50/08; G06Q 10/20

(57) ABSTRACT

Systems and methods are described for determining a candidate route for a pipeline to convey a fluid from a starting location to a destination location over a portion of terrain. Determination of the pipeline route may be based upon multiple aspects of the terrain including for example terrain elevation data and auxiliary terrain data such as terrain type, land ownership, rights-of-way, land use and ease of terrain access. Systems and methods are further described for determining preferred locations of fluid pumps along the candidate route, for example based upon technical requirements of the pipeline. The systems and methods also facilitate user interaction including the display of the determined route and the pump locations.

### RELATED MATTERS

This application claims the benefit of prior U.S. application Ser. No. 62/877,436, filed on Jul. 23, 2019, the entire contents of which are incorporated by reference herein.

### TECHNICAL FIELD

The present invention generally relates to systems and methods for determining a route of a fluid pipeline, and for optimization of a pipeline route to accommodate different types, properties and features of the terrain through which it passes. The invention further relates to systems and methods for determining a placement of fluid pumps along the route of a pipeline based upon multiple criteria including technical requirements of the fluid pipeline and properties of the terrain.

### BACKGROUND

Hydraulic fracturing, or fracking, is the process of injecting a hydraulic liquid such as water or gel into shale rock under pressure in order to create or expand cracks to facilitate the extraction of subterranean natural gas and oil. Use of this technique has grown rapidly in recent years.

Water is not only needed to initiate the fracturing process (the injectate), but may also often be recovered, produced or released as part of the operation. This water may be a return of the injected water or may be underground water that is released as a result of the fracturing. The quantity of the returned water can often be large, for example, exceeding by far the quantity of oil obtained from the well.

The nature of the fracturing process therefore brings about a requirement not only to source large amounts of water at the outset of a project, but also to dispose-of or treat and recycle water during the project or upon its completion. Vehicular transportation of water from one place to another, such as from a water source to an oilfield site, from one oilfield site to another, from an oilfield site to a disposal or storage facility, or to provide interconnection of such sites or facilities to existing or fixed pipeline networks, can incur significant costs and thereby reduce the available margin for profit during production. Costs associated with vehicular transportation include fuel, labor, vehicular maintenance, repair and depreciation in vehicular asset value. Additionally, the capacity or rate by which a fluid may be transported by vehicular means is limited. The practicality and expense of vehicular transportation of fluids may therefore quickly become prohibitive for larger fluid volumes and inter-site distances. Such issues may be further compounded in cases where the intervening terrain between fluid transportation start and destination locations has poor vehicular access or road condition. Costs associated with vehicular transportation of fluids such as oilfield water may be mitigated to some degree by identifying and selecting water source, disposal or treatment options that are geographically local to the fracturing site. However, this is not always possible and there remains a need for a cost-effective solution in such cases.

To overcome the challenges associated with vehicular transportation of oilfield fluids such as water, pipelines may be laid to accomplish the aims of a given oilfield project. For short- or medium-term projects, the pipeline may be temporary, and can be dismantled after project completion. The pipeline may interconnect any suitable fluid transportation start and destination locations, including places of fluid use or production (such as oilfield drilling sites), fluid sources, fluid storage or disposal facilities, fluid treatment or recycling facilities and fixed or permanent pipeline networks or infrastructure.

The laying of such a pipeline naturally incurs financial costs associated with its installation, operation and maintenance and eventual dismantlement. For example, such costs may arise due the need for appropriate design and planning, sourcing of pipeline materials and equipment, labor, fuel, energy, and administrative or permit-related fees. Even so, the use of pipeline-based (as opposed to vehicular-based) transportation of fluids may often be a more cost-effective solution, especially for larger fluid transportation capacities and distances. There is a need to be able to compare the financial merits of such a pipeline against the financial merits of vehicular transportation of fluids to assist planning and investment decisions.

However, whilst the use of fluid pipelines can mitigate the disadvantages associated with vehicular transportation, the laying of a pipeline has its own set of associated challenges. For example, the pipeline route may need to cross terrain of varying elevation, varying terrain type and varying land usage. The route may further need to avoid terrain features or obstacles and may need to transit land owned by multiple third parties for which associated permits may be required. The costs of laying, operating and dismantling the pipeline may also be affected by the ease (or difficulty) of access to the terrain over which it passes.

In addition to the above financial-cost-related aspects, a pipeline must also fulfil its intended purpose and meet the technical requirements of its design. For example, a pipeline is typically designed to achieve a target average or peak flow rate, or to ensure that the internal pressure remains within limits that may be determined by the pipe's material or construction. Key to meeting these technical design requirements is the selection of suitable fluid pumps and pipeline materials and the determination of the locations along the pipeline route where the fluid pumps should be installed.

However, there are also additional factors that are of relevance when optimizing the location of the fluid pumps along the pipeline route. As aforementioned, the type of terrain, its ease of access and its ownership may all affect the ability of the pipeline owner to install and maintain the associated fluid pumps, and this in turn may affect financial costs.

It is evident from the above that the design and routing of fluid pipeline infrastructure is a multi-variate problem that encompasses both technical design aspects as well as additional practical or financial constraints. This gives rise to the technical problem of addressing both the technical design aspects and the additional restraints in a single solution. There is therefore a need for improved systems and methods for determining a route of a fluid pipeline and the locations of fluid pumps along it.

### SUMMARY

In a first example, a method is described for determining a route for a pipeline, the pipeline conveying a fluid from a first geographical location (such as a starting location) to a second geographical location (such as an ending or destination location) via at least one fluid pump. The method comprises receiving both terrain elevation data and auxiliary terrain data (the auxiliary terrain data including at least one of a terrain type, a land ownership, a right of way or permit of land access, a land use and an ease of access) for an area of terrain comprising both the first geographical location and the second geographical location. The method further comprises determining, using a cost function, a plurality of mathematical costs, each associated with installing or operating a segment of pipeline within the terrain, wherein the mathematical costs are based at least on a weighted combination of the terrain elevation data and the auxiliary terrain data. The method further comprises determining a candidate pipeline route based on the plurality of mathematical costs. The method may further comprise comparing the costs of building and operating the candidate pipeline route to the costs associated with the operation of the vehicular transportation of fluids.

In a second example, an interactive user system is described for determining a route for a pipeline conveying a fluid from a first geographical location (such as a starting location) to a second geographical location (such as an ending or destination location) via at least one fluid pump. The system is configured to receive, from a user, the first and second geographical locations in addition to a technical or performance-related requirement of the pipeline. The system may be further configured to determine at least one of a starting location and a destination location based upon existing routes for the vehicular transportation and the fluid volumes and flow rates associated with those routes. The system is further configured to receive both terrain elevation data and auxiliary terrain data. The system is configured to determine a candidate pipeline route based on the terrain elevation data and the auxiliary terrain data and to further determine a set of fluid pump locations along the pipeline route. The system is configured to display the candidate route and the locations of the fluid pumps. Responsive to receiving a modification of the route from a user, the system is configured to determine and display a revised set of fluid pump locations along the modified route.

Other aspects and advantages of the invention will become apparent from the following detailed description, taken in conjunction with the accompanying drawings, which illustrate by way of example the principles of the invention.

### BRIEF DESCRIPTION OF THE DRAWINGS

FIG. 1A is a block diagram depicting an embodiment of a network environment comprising client devices in communication with online platform devices, information storage devices, and server devices, according to some embodiments.

FIG. 1B is a block diagram depicting a cloud computing environment comprising client devices, for example user device and subscriber device, in communication with cloud service providers, according to some embodiments.

FIGS. 1C and 1D are block diagrams depicting embodiments of computing devices useful in connection with the methods and systems described herein.

FIG. 2A shows a system suitable for determining pipeline routes and fluid pump locations and for providing associated information to a user of an online platform, according to some embodiments.

FIG. 2B shows examples of inputs and outputs of a pipeline design assistant, according to some embodiments.

FIG. 2C shows one example configuration of a pipeline design assistant according to some embodiments.

FIG. 3A illustrates an example of a method for determining pipeline routes and fluid pump locations, according to some embodiments.

FIG. 4A illustrates an example of features and properties of a portion of terrain through which a pipeline is to be routed.

FIG. 4B illustrates a simple mathematical graph comprising nodes interconnected by edges.

FIG. 4C illustrates a computation of edge values as a difference between terrain element values.

FIG. 5A illustrates a first cost function surface used to determine a first candidate pipeline route, according to some embodiments.

FIG. 5B illustrates a second cost function surface used to determine a second candidate pipeline route, according to some embodiments.

FIG. 6A illustrates a first candidate pipeline route and fluid pump locations across a portion of terrain, according to some embodiments.

FIG. 6B illustrates a second candidate pipeline route and fluid pump locations across a portion of terrain, according to some embodiments.

### DETAILED DESCRIPTION

In light of the need for efficient water management in the energy industry, tools to facilitate a dynamic online platform for water sourcing, recycling and disposal may be employed in which buyers and sellers of water source or disposal capacity may exchange information related to either an availability-of or a requirement-for water, including a number of relevant attributes such as its quantity, location, type, and quality. Such a platform may address not only the water resource needs associated with oilfield exploration and development, but also the need and supply of other associated oilfield resources, services, or infrastructure.

Whilst such online platforms assist with the oilfield water marketplace in general, there remains a need to ultimately transport oilfield water between locations and to determine how this may be optimized. Vehicular transportation of fluids is one possibility (for example, via fluid container trucks) whilst the use of a temporary or permanent pipeline is another. The selection of which method to use will often be made based on an estimate of the financial costs associated with each method. Such costs are in-turn a function of numerous other factors associated with i) the fluid itself (for example, the volume and type of fluid to be transported), ii) the terrain between the start and destination locations (for example, the distance over which it must travel, the elevation profile, the type of terrain and features or obstacles within it, the use and ownership of the land, the ease of access and so on), and iii) other non-terrain-related factors such as truck or pipeline capacity, and the cost of fuel, labor, or materials.

The difference in cost between a well-optimized fluid transportation solution and one that is poorly optimized can be highly significant, hence it is important to carefully plan the solution and to account for the multitude of factors that contribute to its eventual cost and performance.

The disclosure herein provides a technical solution to these problems and describes systems and methods for determining an optimized route for a fluid pipeline between a starting location and a destination location and for determining an optimized placement of fluid pumps along the pipeline length. The systems and methods allow for an improved planning and design of fluid transportation pipelines in accordance with defined and potentially multi-faceted optimization criteria. In examples, the optimization criteria may comprise an overall lifetime cost of a hypothetical temporary pipeline. In other examples, the optimization criteria may allow for a balanced trade-off to be found between multiple competing requirements, such as minimum cumulative elevation gain, maximum ease of access for installation and maintenance, minimum permit requirements, minimum operating expenditure, maximum technical performance and so forth.

Embodiments of the disclosure may extend the capabilities of an online platform for oilfield water management by providing a pipeline design assistant software application capable of determining candidate pipeline routes and pump locations in accordance with user-supplied input on optimization criteria, routing preferences and technical requirements.

For the purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods that provide the technical solution of determining and optimizing pipeline routes and fluid pump locations.

### A. Computing and Network Environment

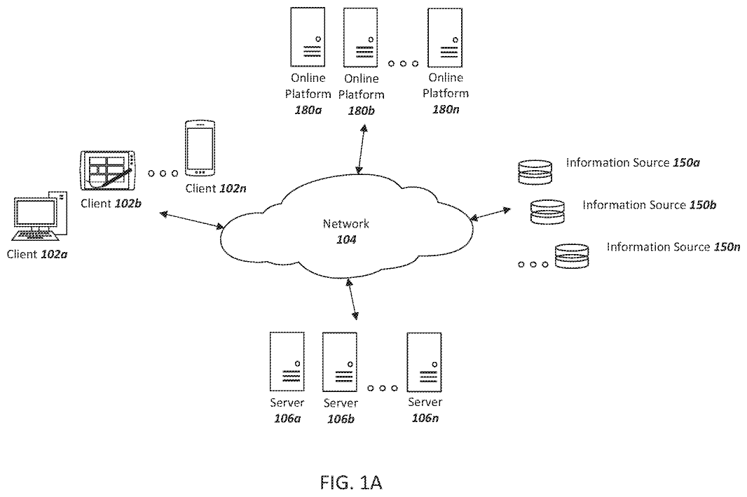

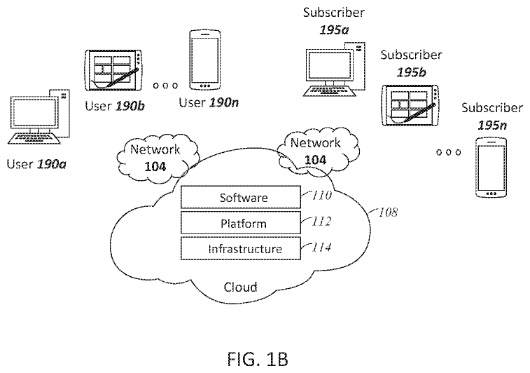

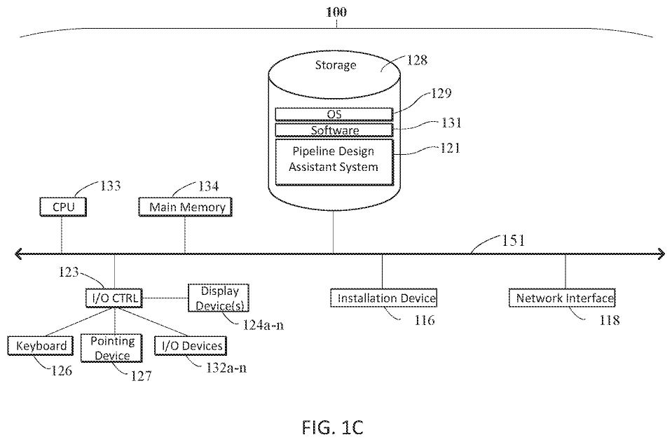

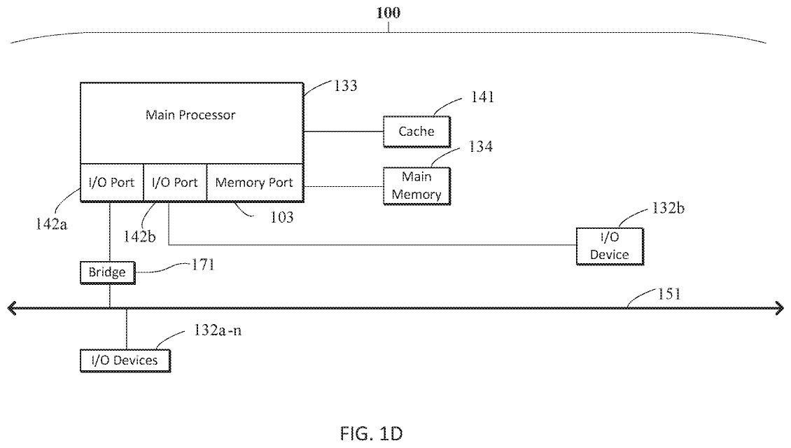

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment may include one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106), one or more online platforms 180a-180n (also generally referred to as online platforms(s) 180, platform node(s) 180, platform machine(s) 180, or remote online platform machine(s) 180), one or more information source 150a-150n (also generally referred to as information source(s) 150, record node(s) 150, record machine(s) 150, or remote record machine(s) 150) via one or more networks 104. In some embodiments, one or more of client 102, online platform 180, or information source 150 has the capacity to function as both a node seeking access to resources provided by a server and as a server providing access to hosted resources for other clients 102a-102n, online platforms 180a-180n, and information sources 150a-150n. Examples of client(s) 102 includes user(s) 190 and subscriber(s) 195.

Although FIG. 1A shows a network 104 between clients 102, online platforms 180, information source 150 and the servers 106, in examples clients 102, online platforms 180, information source 150 and servers 106 may be on the same network 104. In some embodiments, there are multiple networks 104 between clients 102, online platforms 180, information source 150 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks. Servers 106 may be used to generically refer to all of online platforms 180, information source 150 and servers 106. Clients 102, online platforms 180, and information source 150 may process input from server 106 and/or may provide access as needed to various applications, modules, and other software components of server 106 to other various applications, modules, and other software components of server 106.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1xRTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g., Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv4), or the link layer. The network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Wash.), while one or more of the other servers 104 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 104 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, Calif.; the Xen hypervisor, an open source product whose development is overseen by Citrix Systems, Inc. of Fort Lauderdale, Florida; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, Calif.

Management of the machine farm may be de-centralized. For example, one or more servers 106 may comprise components, subsystems and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106, online platform 180, and information source 150 may be a file server, application server, web server, proxy server, appliance, network appliance, gateway, gateway server, virtualization server, deployment server, SSL VPN server, or firewall. In one embodiment, a plurality of servers 106, online platforms 180 and information sources 150 may be in the path between any two communicating servers 106, online platforms 180 or information sources 150.

Referring to FIG. 1B, a cloud computing environment is depicted. A cloud computing environment may provide user 190 and subscriber 195 with one or more resources provided by a network environment. The cloud computing environment may include one or more users 190a-190n and one or more subscribers 195a-195n in communication with the cloud 108 over one or more networks 104. Users 190 and subscribers 195 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for user 190 or subscriber 195. The cloud 108 may include back end platforms, e.g., servers 106, storage, server farms or data centers.

The cloud 108 may be public, private, or hybrid. Public clouds may include public servers 106 that are maintained by third parties to client(s) 102, for example user(s) 190 and subscriber(s) 195 or owners of client(s) 102, user(s) 190, and/or subscriber(s) 195. The servers 106 may be located off-site in remote geographical locations as disclosed above or otherwise. Public clouds may be connected to the servers 106 over a public network. Private clouds may include private servers 106 that are physically maintained by client(s) 102, for example user(s) 190 and/or subscriber(s) 195 or owners of client(s) 102, user(s) 190, and/or subscriber(s) 195. Private clouds may be connected to the servers 106 over a private network 104. Hybrid clouds may include both private and public networks 104 and servers 106.

Cloud 108 may also include a cloud-based delivery, e.g., Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers or virtualization, as well as additional resources, e.g., the operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g., Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Client(s) 102, for example user(s) 190 and/or subscriber(s) 195 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Client(s) 102, for example user(s) 190 and/or subscriber(s) 195 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Client(s) 102, for example user(s) 190 and/or subscriber(s) 195 may access SaaS resources through the use of web-based user interfaces, provided by a web browser (e.g., Google Chrome, Microsoft Internet Explorer, or Mozilla Firefox provided by Mozilla Foundation of Mountain View, Calif.). Client(s) 102, for example user(s) 190 and/or subscriber(s) 195 may also access SaaS resources through smartphone or tablet applications, including e.g., Salesforce Sales Cloud, or Google Drive App. Client(s) 102, for example user(s) 190 and/or subscriber(s) 195 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

Client(s) 102, for example user(s) 190 and/or subscriber(s) 195 and server 106 may be deployed as and/or executed on any type and form of computing device, e.g., a computer, network device or appliance capable of communicating on any type and form of network and performing the operations described herein.

FIGS. 1C and 1D depict block diagrams of a computing device 100 useful for practicing an embodiment of the client 102, online platform 180, information source 150 and the server 106. As shown in FIGS. 1C and 1D, each computing device 100 includes a central processing unit 133, and a main memory unit 134. As shown in FIG. 1C, a computing device 100 may include a storage device 128, an installation device 116, a network interface 118, an I/O controller 123, display devices 124a-124n, a keyboard 126 and a pointing device 127, e.g., a mouse. The storage device 128 may include, without limitation, an operating system 129, software 131, and a software of a pipeline design assistant system 121. As shown in FIG. 1D, each computing device 100 may also include additional optional elements, e.g., a memory port 103, a bridge 171, one or more input/output devices 132a-132n (generally referred to using reference numeral 132), and a cache memory 141 in communication with the central processing unit 133.

The central processing unit 133 is any logic circuity that responds to and processes instructions fetched from the main memory unit 134. In many embodiments, the central processing unit 133 is provided by a microprocessor unit, e.g.: those manufactured by Intel Corporation of Mountain View, Calif.; those manufactured by Motorola Corporation of Schaumburg, Illinois; the ARM processor and TEGRA system on a chip (SoC) manufactured by Nvidia of Santa Clara, Calif.; the POWER4 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 133 may utilize instruction level parallelism, thread level parallelism, different levels of cache, and multi-core processors. A multi-core processor may include two or more processing units on a single computing component. Examples of multi-core processors include the AMD PHENOM IIX2, INTER CORE i5 and INTEL CORE i4.

Main memory unit 134 may include on or more memory chips capable of storing data and allowing any storage location to be directly accessed by the microprocessor 133. Main memory unit 134 may be volatile and faster than storage 128 memory. Main memory units 134 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 134 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 134 may be based on any of the above described memory chips, or any other available memory chips capable of operating as described herein. In the embodiment shown in FIG. 1C, the processor 133 communicates with main memory 134 via a system bus 151 (described in more detail below). FIG. 1D depicts an embodiment of a computing device 100 in which the processor communicates directly with main memory 134 via a memory port 103. For example, in FIG. 1D the main memory 134 may be DRDRAM.

FIG. 1D depicts an embodiment in which the main processor 133 communicates directly with cache memory 141 via a secondary bus, sometimes referred to as a backside bus. In other embodiments, the main processor 133 communicates with cache memory 141 using the system bus 151. Cache memory 141 typically has a faster response time than main memory 134 and is typically provided by SRAM, B SRAM, or EDRAM. In the embodiment shown in FIG. 1D, the processor 133 communicates with various I/O devices 132 via a local system bus 151. Various buses may be used to connect the central processing unit 133 to any of the I/O devices 132, including a PCI bus, a PCI-X bus, or a PCI-Express bus, or a NuBus. For embodiments in which the I/O device is a video display 124, the processor 133 may use an Advanced Graphic Port (AGP) to communicate with the display 124 or the I/O controller 123 for the display 124. FIG. 1D depicts an embodiment of a computer 100 in which the main processor 133 communicates directly with I/O device 132b or other processors 133′ via HYPERTRANSPORT, RAPIDIO, or INFINIBAND communications technology. FIG. 1D also depicts an embodiment in which local busses and direct communication are mixed: the processor 133 communicates with I/O device 132a using a local interconnect bus while communicating with I/O device 132b directly.

A wide variety of I/O devices 132a-132n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 132a-132n may include a combination of multiple input or output (I/O) devices, including, e.g., Microsoft KINECT, Nintendo Wiimote for the WII, Nintendo WII U GAMEPAD, or Apple iPhone. Some I/O devices 132a-132n allow gesture recognition inputs through combining some of the inputs and outputs. Some I/O devices 132a-132n provide for facial recognition which may be utilized as an input for different purposes including authentication and other commands. Some I/O devices 132a-132n provide for voice recognition and inputs, including, e.g., Microsoft KINECT, SIRI for iPhone by Apple, Google Now or Google Voice Search, and Alexa by Amazon.

Additional I/O devices 132a-132n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 132a-132n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation device 116 for the computing device 100. In still other embodiments, the computing device 100 may provide USB connections (not shown) to receive handheld USB storage devices. In further embodiments, a I/O device 132 may be a bridge between the system bus 151 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 132a-132n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g., one or more hard disk drives or redundant arrays of independent disks) for storing an operating system or other related software, and for storing application software programs such as any program related to the pipeline design assistant system software 121. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 151. Some storage device 128 may be external and connect to the computing device 100 via an I/O device 132 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116 and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1C and 1D may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 4, WINDOWS RT, WINDOWS 8 and WINDOW 10, all of which are manufactured by Microsoft Corporation of Redmond, Wash.; MAC OS and iOS, manufactured by Apple, Inc.; and Linux, a freely-available operating system, e.g., Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 340 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M9A/AAC, WMA Protected AAC, AIFF, Audible audiobook, Apple Lossless audio file formats and .mov, .m4v, and .mp4 MPEG-4 (H.244/MPEG-4 AVC) video file formats.

In some embodiments, the computing device 100 is a tablet e.g., the IPAD line of devices by Apple; GALAXY TAB family of devices by Samsung; or KINDLE FIRE, byAmazon.com, Inc. of Seattle, Wash. In other embodiments, the computing device 100 is an eBook reader, e.g., the KINDLE family of devices by Amazon.com, or NOOK family of devices by Barnes & Noble, Inc. of New York City, N.Y.

In some embodiments, client 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, client 102 is a laptop or desktop computer equipped with a web browser and a microphone and speaker system, e.g., a telephony headset. In these embodiments, the client(s) 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. MAIN DESCRIPTION

The following describes systems and methods that are useful for determining and optimizing pipeline routes and fluid pump locations.

To determine a truly optimized route for a fluid pipeline (and to optimize the placement of fluid pumps along the pipeline route), many different factors must be considered and the complexity of the problem can quickly become problematic and unmanageable. In addition to meeting the technical design requirements of the pipeline (for example to ensure that specified flow-rates are achieved or that internal pipeline pressure limits are not exceeded), it is also desirable to optimize the pipeline route and its design from a financial cost perspective. Such financial costs may in-turn be influenced by the type, ownership, land-use and elevation profile of the terrain over which the pipeline is to be routed, the ease of access to key points along the pipeline route for installation and maintenance purposes, the sourcing, availability and location of suitable pipeline products and so forth.

To address such a multi-variate optimization problem, embodiments of the present disclosure provide computer-implemented systems and methods in which pipeline routes are determined using a mathematical cost function surface that is constructed across the terrain of interest. The mathematical cost function surface may be a complex function of the multiple (and potentially competing) input and optimization requirements and may be flexibly configured according to the needs of the user of the system or its administrator(s). In examples, at least one of the starting location and the destination location may be determined based upon existing routes for the vehicular transportation and the fluid volumes and flow rates associated with those routes.

Once a mathematical cost function surface across the terrain has been constructed, embodiments of the computer-implemented systems and methods may automatically determine one or more pipeline routes that minimize or reduce an overall mathematical cost associated with the route. In examples, the overall mathematical cost of a route may be a summation of a set of mathematical costs, each member of the set associated with a segment or component of the pipeline along the route. Exhaustive or guided non-exhaustive route-finding algorithms may be employed to identify such minimum-cost or low-cost routes through the mathematical cost function surface. In examples, the cost of the route may be compared to the use of the vehicular transportation of fluids between the same starting location and destination location as the pipeline route.

Further details of the disclosed systems and methods are provided by means of the accompanying figures and description as follows.

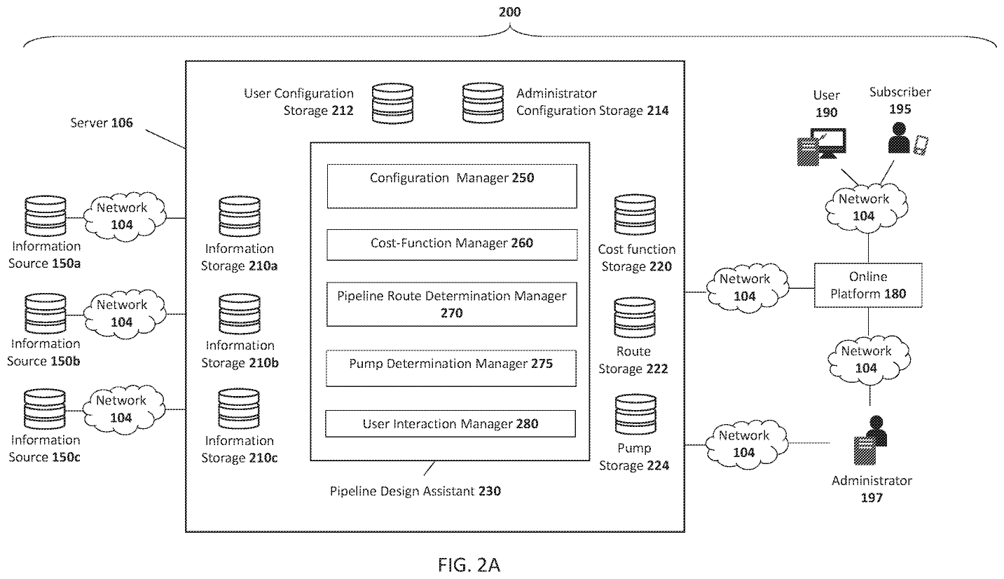

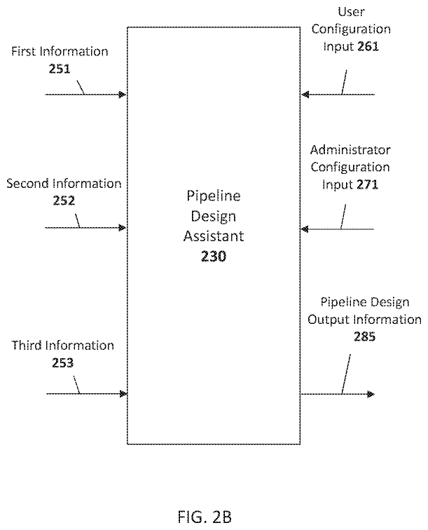

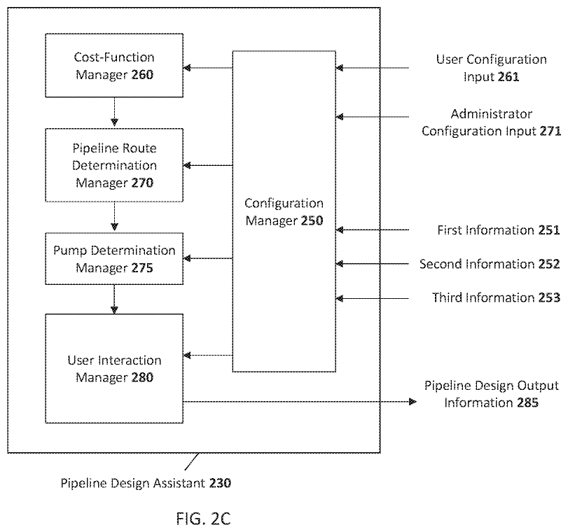

In a general overview, FIG. 2A shows a system 200 which may be configured to determine pipeline routes between locations within an area of terrain. System 200 may also be configured to determine fluid pump locations along a pipeline route.

Referring to FIG. 2A in more detail, system 200 may comprise one or more servers 106, one or more information sources 150a, 150b and 150c, one or more online platforms 180 and one or more clients 102 operated by users 190, subscribers 195 or administrators 197.

Any of server 106, information sources 150a-c, online platform 180, and clients 102 of users 190, subscribers 195 and administrators 197 may be connected to one another via wired or wireless means, and such a connection may be either direct or may traverse a network 104. For ease of illustration, example connections of FIG. 2A are shown traversing a network 104 though such a network need not be present and may be replaced with a direct connection or no connection at all.

Some embodiments of system 200 may include, for example within server 106, a pipeline design assistant 230 configured to determine and optimize pipeline routes as well as to determine fluid pump locations along a proposed pipeline route. In examples, pipeline design assistant 230 may optionally comprise a configuration manager 250, a cost-function manager 260, a pipeline route determination manager 270, a pump determination manager 275 and a user interaction manager 280.

Server 106 may be configured to be connected to one or more information sources 150a-c which may possess certain attributes or characteristics. For example, any of information sources 150a-c may be privately or publicly owned or may be local or remote to server 106. Further example characteristics of information sources 105a-150c may be that the information they comprise is freely or publicly accessible or has restricted access for example only to users of a specific entity, or group. Yet further characteristics of information sources 150a-c may be that the information they comprise is available with or without a financial cost or subscription. It shall be appreciated that such characteristics are exemplars only hence do not limit the scope of the description and other equivalent or similar information sources may be equally suitable for use within system 200.

In embodiments, server 106 may comprise information storage, such as information storages 210a, 210b and 210c. In some embodiments, information storage 210a may be configured to provide local storage for first information retrieved or received from information source 150a, information storage 210b may be configured to provide local storage for second information retrieved or received from information source 150b and information storage 210c may be configured to provide local storage for third information retrieved or received from information source 150c.

In examples, server 106 may also comprise additional storages, such as user configuration storage 212, administrator configuration storage 214, cost function storage 220, route storage 222 and pump storage 224. User configuration storage 212 may be configured to receive and store user configuration input provided by a user 190 or subscriber 195 of an online platform 180 and to provide stored user configuration input to other functions or processes residing within server 106, such as to configuration manager 250. Administrator configuration storage 214 may be configured to receive and store administrator configuration input provided by an administrator 197 of an online platform 180 and to provide stored administrator configuration input to other functions or processes residing within server 106, such as to configuration manager 250. Cost function storage 220 may be configured to receive and store cost function information from other functions or processes residing within server 106, such as from configuration manager 250 or cost function manager 260. Cost function storage 220 may further be configured to provide stored cost function information to other functions or processes residing within server 106, such as to cost function manager 260 or pipeline route determination manager 270. Route storage 222 may be configured to receive and store pipeline route information from other functions or processes residing within server 106, such as from pipeline route determination manager 270 and may further be configured to provide stored pipeline route information to other functions or processes residing within server 106, such as to pump determination manager 275 or to user interaction manager 280.

Any of pipeline design assistant 230, configuration manager 250, cost-function manager 260, pipeline route determination manager 270, pump determination manager 275, user interaction manager 280, information storages 210a-c, user configuration storage 212, administrator configuration storage 214, cost function storage 220, route storage 222 and pump storage 224 may be configured to be connected to one another within server 106 to exchange data and information therebetween. Furthermore, any of pipeline design assistant 230, configuration manager 250, cost-function manager 260, pipeline route determination manager 270, pump determination manager 275, user interaction manager 280, information storages 210a-c, user configuration storage 212, administrator configuration storage 214, cost function storage 220, route storage 222 and pump storage 224 may be configured to be connected to entities, processes or functions residing externally to server 106 (such as information sources 150a-c, online platform 180 and clients 102 of user 190, subscriber 195 or administrator 197) to exchange data and information therebetween.

FIG. 2B shows examples of inputs and outputs of a pipeline design assistant, according to some embodiments. The pipeline design assistant 230 processes a variety of different inputs in order to determine pipeline design output information 285.

Table 1 lists example inputs that may be received by a pipeline design assistant 230. These are shown for illustrative purposes. It shall be appreciated that additional input information may also be received by pipeline design assistant in to order to determine pipeline design output information 285.

TABLE 1
Example Inputs to a Pipeline Design Assistant

| Input | Examples of information content |
|---|---|
| First Information 251 | Topological elevation data in any suitable format |
| Information on | Examples include an (x, y, z) triple in which x and y |
| the elevation profile of a | are longitudinal and latitudinal coordinates respectively, |
| portion of terrain through | and z is an elevation relative to a datum such as mean sea |
| which a pipeline may be | level |
| routed, e.g., terrain | |
| elevation data | |
| Second Information 252 | Terrain type |
| Auxiliary (e.g. | e.g. grassland, woodland, forest, scrub, rocky, |
| non-elevation-related) | marsh, desert, suburban, developed |
| information on a portion | Terrain features and obstacles |
| of terrain through which | e.g. buildings, roads, lakes, rivers, electrical |
| a pipeline may be routed, | distribution infrastructure, fences, oilfield sites and |
| e.g., auxiliary terrain data | facilities |
| | Land ownership |
| | e.g. private, public, specific owner |
| | Land use |
| | e.g. unused, agricultural, public services and |
| | infrastructure, domestic, light industrial, heavy industrial |
| | Rights of way |
| | e.g. existing rights of way or permitted access, type |
| | of permit (such as to cross a road, private land, government |
| | property, nature reserve or water course), information on |
| | previously-granted permits, temporal aspects of permits |
| | (permanent, temporary, time periods or schedules for |
| | access) |
| | Ease of access |
| | e.g. on foot, by vehicle or by air |
| | distance to nearest path, nearest road, nearest |
| | airstrip or helipad |
| Third Information 253 | Technical fluid pump data |
| Non-terrain-related | e.g. product information of available fluid pumps |
| information | pump types |
| | pump capacities |
| | pump flowrates |
| | operating pressures |
| | energy consumption |
| | efficiency, maintenance schedule, communications |
| | capability and ability to remotely control |
| | Technical pipe data |
| | e.g. product information of available pipes and |
| | fitments |
| | size or diameter |
| | wall material |
| | maximum allowable operating pressure (MAOP) |
| | thermal properties |
| | friction loss |
| | In-the-field technical performance data |
| | e.g. sensor measurements made on installed |
| | pipelines |
| | fluid temperatures |
| | fluid pressures |
| | fluid flowrates |
| | fluid viscosities |
| | pump speeds |
| | Labor costs |
| | e.g. hourly rates for manpower, hours per task |
| | Fuel and energy costs |
| | e.g. for vehicular fuel, pump fuel, electrical |
| | supplies |
| | Materials costs |
| | e.g. for fluid pumps, pipes, couplings, electrical |
| | generators |
| | Equipment and Resources |
| | e.g. a location or availability of equipment, |
| | resources or materials |
| | e.g. existing routes for the vehicular transportation |
| | and the fluid volumes and flow rates associated with those |
| | routes |
| User configuration input 261 | Technical or performance-related requirements |
| Configuration | e.g. |
| information input by a | fluid type to be conveyed |
| user 190 or subscriber | fluid viscosity |
| 195 of system 200 | mean flow rates |
| | peak flow rates |
| | thermal requirements |
| | maximum pipeline pressure |
| | maximum energy consumption |
| | maximum cumulative elevation gain |
| | maximum net elevation gain |
| | maximum number of fluid pumps |
| | pipeline lifespan requirements |
| | pipeline or pump product, manufacturer or supplier |
| | required operating pressure at pipe outlet |
| | Access Requirements |
| | e.g. |
| | access to pipeline or fluid pumps for maintenance |
| | (on foot, by vehicle or by air) |
| | maximum distance to road |
| | minimum width of road |
| | allowable road surface types |
| | Routing requirements |
| | e.g. |
| | location information |
| | starting point |
| | destination point |
| | intermediate or waymark points |
| | pipeline geo-fence |
| | permissible crossings-the degree of user |
| | allowance or disallowance of the crossing of: |
| | roads, road types, watercourses |
| | land of a given ownership (private, public, specific |
| | owner) |
| | a terrain type, feature or obstacle |
| | terrain of a given land use |
| | land requiring permitted access or land for which |
| | only scheduled/time-restricted access is possible |
| | Optimization or ranking criteria |
| | e.g. |
| | mathematical routing cost |
| | of a route across a cost-function surface |
| | financial expenditure |
| | installation costs |
| | operation and maintenance costs |
| | deinstallation costs |
| | total cost of ownership |
| | total pipeline distance |
| | time period for which the pipeline will operate |
| | cumulative elevation gain |
| | number of fluid pumps |
| | performance against technical or performance- |
| | related user requirements |
| | performance against user routing preferences and |
| | constraints |
| | Output content, format and display |
| | e.g. user configuration of the content, format or |
| | display of the pipeline design output information to be |
| | provided by the system to the user |
| Administrator | User interface configuration |
| configuration input 271 | e.g. administrator configuration of: |
| Configuration | the technical or performance-related requirements |
| information input by an | available for selection by the user |
| administrator 197 of | the access requirements available for selection by |
| system 200 | the user |
| | the routing requirements available for selection by |
| | the user |
| | the optimization or ranking criteria available for |
| | selection by the user |
| | the content, format or display of pipeline design |
| | output information to the user |
| | Cost function configuration |
| | e.g. mathematical weights or parameters associated |
| | with any of: |
| | technical or performance related requirements |
| | access requirements |
| | routing requirements |
| | optimization or ranking criteria |
| | Routing algorithm configuration |
| | e.g. administrator configuration of: |
| | a routing algorithm or type |
| | algorithm parameters |
| | Default parameters |
| | e.g. for optimization or ranking criteria, cost- |
| | function weights or parameters, routing algorithm type, or |
| | content or format of pipeline design output information. |

In operation, pipeline design assistant 230 receives input information (such as first input information 251, second input information 252 and third input information 253, user configuration input 261 and administrator configuration input 271) and processes the input information to determine pipeline design output information 285.

In examples, pipeline design output information 285 may be returned to a user 190 or subscriber 195 of an online platform 180. Depending on the user's or administrator's configuration of pipeline design assistant 230, the pipeline design output information 285 may comprise a single pipeline route determined and selected by the pipeline design assistant 230. In examples, the pipeline design output information 285 may comprise a set of candidate pipeline routes determined by the pipeline design assistant 230 for consideration by the user, or from which the user may then subsequently select. In examples, the pipeline design output information 285 may comprise a set of candidate pipeline routes where at least one of the starting location or destination location have been determined by the pipeline design assistant 230 for consideration by the user, or from which the user may then subsequently select. The pipeline design output information 285 may further comprise additional technical or non-technical details concerning the selected or candidate routes. In general, pipeline design output information 285 may comprise one or more of the following content types as listed in Table 2:

TABLE 2
Example content of pipeline design output information

| Content of pipeline design | |
|---|---|
| output information | Description |
| A selected pipeline route | A pipeline route determined and selected by |
| | pipeline design assistant 230 based at least on user |
| | configuration input 261 |
| A candidate pipeline route | One of a potential plurality of pipeline routes |
| | determined by pipeline design assistant 230 for |
| | selection or consideration by a user |
| Fluid pump locations | Geographical locations of fluid pumps determined |
| | by pipeline design assistant 230 along a selected |
| | or candidate pipeline route. |
| Fluid pump requirements | A type, capacity, flow rate, pressure rating, |
| | product manufacturer, model number or other |
| | requirement of a fluid pump at a respective |
| | location along a selected or candidate pipeline |
| | route. |
| Pipe requirements | A type, size or diameter, wall material, pressure |
| | rating, thermal rating or other requirement of a |
| | pipe or pipe fitment at a respective location along |
| | a selected or candidate pipeline route. |
| A ranking or score of a selected or | Pipeline design assistant 230 may assign a rank or |
| candidate pipeline route | a score to selected or candidate pipeline routes. |
| | This may be based on one or more satisfaction |
| | metrics indicative of a degree to which the route |
| | meets the requirements of user configuration input |
| | 261. Alternatively, the ranking or score may be |
| | based on an elevation gain, a number of required |
| | fluid pumps, a technical performance metric, a |
| | mathematical routing cost or a financial cost. |
| | More generally, the ranking or score may be based |
| | on any of the optimization or ranking criteria |
| | listed within the user configuration input of Table |
| | 1. |
| Technical and performance data | Technical information concerning a selected or |
| | candidate pipeline route. This may comprise: |
| | a cumulative elevation gain |
| | a net elevation gain |
| | an elevation gain between two consecutive |
| | fluid pumps along the pipeline route |
| | a mean or peak flow rate |
| | a maximum fluid pressure |
| | a plurality of fluid pressures at respective |
| | locations along the pipeline route |
| | an energy consumption of fluid pumps |
| | along the pipeline route |
| | one or more temperatures or thermal |
| | properties at locations along the pipeline route |
| | one or more fluid viscosities at locations |
| | along the pipeline route |
| | an expected pipeline lifespan |
| Materials and resources | Time or fiscal cost estimates associated with labor |
| information | for: |
| | pipeline installation |
| | pipeline operations and maintenance |
| | pipeline deinstallation |
| | Fuel or energy costs associated with: |
| | pipeline installation |
| | pipeline operations and maintenance |
| | pipeline deinstallation |
| | Lists or fiscal costs of required products, |
| | equipment or materials e.g. |
| | pipes |
| | pipe fitments |
| | ground footings and anchors |
| | fluid pumps |
| | electrical cabling |
| | Total fiscal costs associated with the pipeline, for |
| | example, over its design lifespan. |

FIG. 2C illustrates further detail of an example pipeline design assistant 230 according to some embodiments. As shown in FIG. 2C, pipeline design assistant 230 may comprise one or more of; a configuration manager 250, a cost-function manager 260, a pipeline route determination manager 270, a pump determination manager 275 and a user interaction manager 285.

Configuration manager 250 may be configured to receive one or more inputs such as user configuration input 261, administrator configuration input 271, first information 251, second information 252 or third information 253 and to process these inputs to further configure cost-function manager 260, pipeline route determination manager 270, pump determination manager 275 or user interaction manager 280.

The ensemble of information input to pipeline design assistant 230 (comprising user configuration input 261, administrator configuration input 271, first information 251, second information 252 or third information 253) shall hereon be referred-to as “pipeline design assistant inputs”.

Configuration manager 250 may process the pipeline design assistant inputs to identify information that comprises or is otherwise related to either a mathematical cost-function parameter or weight, or to a data input used for the calculation of a mathematical cost-function surface, and may pass such information to cost function manager 260.

In embodiments, information related to a mathematical cost-function parameter or weight may be comprised within user configuration input 261, or administrator configuration input 271. By means of example, user configuration input 261 may comprise a user-specified routing requirement to stipulate that pipeline routes requiring permits to cross privately-owned land are not preferred, hence this information is identified and forwarded by configuration manager 250 to cost-function manager 260 such that a large cost-function weighting parameter (associated with a high mathematical cost) may be assigned to areas of terrain that are privately owned. By means of a further example, user configuration input 261 may comprise a user-specified technical requirement to stipulate that the type of fluid to be conveyed by the pipeline is saltwater. Configuration manager 250 may be configured (for example by an administrator 297 and via administrator configuration input 271) to disallow the routing of salt-water through agricultural land due to potential environmental hazards associated with any potential leak. Hence, configuration manager 250 may pass appropriate information to cost-function manager 260 such that a large cost-function weighting parameter (associated with a high mathematical cost) may be assigned to areas of terrain with a land use categorized as agricultural.

In embodiments, information related to a data input used for the calculation of a mathematical cost-function surface may be comprised within first information 251, second information 252 or third information 253. By means of example, a user 190 may specify in user configuration input 261, a starting location and a destination location of a pipeline route, and configuration manager 250 may subsequently obtain (for example, from information storage 210a), first information 251 comprising topological elevation data for an area of terrain spanning a contiguous area of terrain that includes the starting and destination points.

In embodiments, third information 253 may include existing routes for the vehicular transportation and the fluid volumes and flow rates associated with those routes. In embodiments configuration manager 250 may obtain (for example, from information storage 210c) the routes that are frequently used for the vehicular transportation of fluids. In embodiments the third information 253 may be used to determine candidate pipeline routes including at least one of a starting location or destination points. Configuration manager 250 may forward such elevation data to cost-function manager 260 in order that the elevation data may be used to calculate a mathematical cost-function surface. By means of a further example, a user 190 may specify in user configuration input 261, that the crossing of private land is only permissible for a pipeline route if an existing permit or right of way is already granted and will remain in force for at least one year (i.e. pipeline routes requiring new permit applications are not permitted). Subsequently, configuration manager 250 may obtain (for example, from information storage 210b), second information 252 comprising the locations of known permanent rights of way or routes for which temporary access consent extending at least one year into the future has been granted. Configuration manager 250 may forward such information to cost-function manager 260 in order that it may be used to calculate a mathematical cost-function surface, for example, by reducing the mathematical cost in areas of terrain that follow the identified rights of way or paths of access consent.

Configuration manager 250 may further process the pipeline design assistant inputs to identify information that comprises or otherwise relates to a route-finding algorithm to be used by pipeline route determination manager 270 and may pass such information on to pipeline route determination manager 270. In embodiments, such information may be comprised within user input configuration 260 or administrator configuration input 271. By means of example, administrator configuration input 271 may comprise a first parameter stipulating the use of a particular type of route-finding algorithm and user configuration input 261 may comprise a second parameter stipulating that three candidate routes are to be returned by pipeline design assistant 230. In such cases, configuration manager 250 may configure pipeline route determination manager 270 in order to govern its mode of operation accordingly. In extension to this example, user configuration input 261 may also comprise a third parameter stipulating cumulative elevation gain as a ranking criterion. Configuration manager 250 may subsequently configure pipeline route determination manager 270 to determine a cumulative elevation gain for each of the three lowest-cost routes that are identified and to assign a ranking in accordance.

Configuration manager 250 may further process the pipeline design assistant inputs to identify information that comprises or otherwise relates to a pump placement and determination algorithm to be used by pump determination manager 275 and may pass such information on to pump determination manager 275. In embodiments, such information may be comprised within user input configuration 260 or administrator configuration input 271. By means of example, user configuration input 261 may comprise a technical requirement for a maximum pipeline pressure and configuration manager 250 may pass such information to pump determination manager 275 in order that pump determination manager 275 may determine pump locations (at associated elevations) along a pipeline route that would not result in pipeline pressures exceeding the stipulated requirement.

Configuration manager 250 may further process the pipeline design assistant inputs to identify information that comprises or otherwise relates to a content, format or display of pipeline design output information 285 to be returned by pipeline design assistant 230 and may pass such information to user interaction manager 280. By means of example, user configuration input 261 may comprise a first display parameter stipulating that pipeline pressures along a pipeline route are to be displayed, for example to a user 190 or subscriber 195 of an online platform 180. User configuration input 261 may further comprise a second display parameter to select how the pipeline pressures are to be shown, for example the second display parameter may identify one of two alternatives; i) a 2-dimensional graph of pipeline distance (X) versus pressure (Y), or ii) a color coded representation of the pipeline route across the terrain in 3-dimensional (X,Y,Z) space, with color denoting the pipeline pressure. User configuration manager 250 may subsequently configure user interaction manager 280 such that the appropriate plots may be computed and returned to the user or subscriber within pipeline design output information 285 for subsequent display.

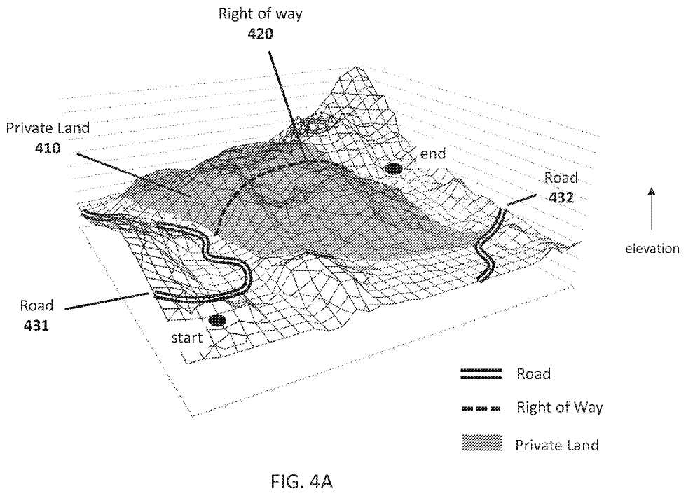

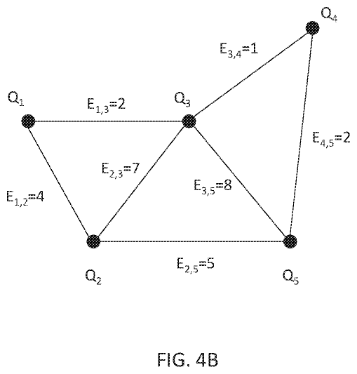

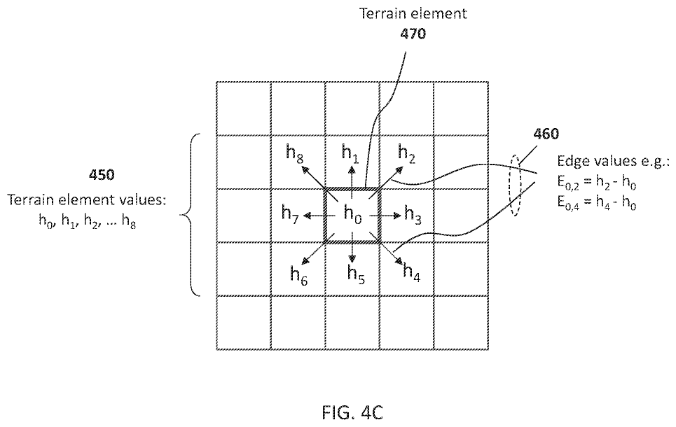

Further details concerning the operation of cost-function manager 260, route determination manager 270 and pump determination manager 275 shall be further described with reference to an exemplary scenario as is further illustrated in FIGS. 4A, 5A, 5B, 6A and 6B.

FIG. 4A illustrates an exemplary portion of terrain through which a pipeline is to be routed. The mesh grid provides a 3-dimensional representation of the elevation at the terrain surface. The portion of terrain comprises a starting point denoted “start” and a destination point denoted “end”. For illustrative purposes, a number of features and properties of the terrain are also shown. In particular, two roads (431 and 432) are depicted in addition to an area of privately-owned land 410 and a right of way across the privately-owned land 420. In this example, areas of the terrain that are not designated as private land are publicly-owned.

In examples, the area of terrain to be modelled may be sub-divided into a plurality of two-dimensional terrain elements within each of which the properties of the terrain may be assumed to be homogenous. By means of illustration, a terrain element may for example correspond to one of the small “mesh-grid-squares” as shown in FIG. 4A. In examples, each terrain element may then be associated with a single terrain type, a single land ownership designation, a single elevation and so forth. The accuracy (or resolution) of the model may be increased or decreased by sub-dividing the terrain into a larger or smaller number of terrain elements respectively. For convenience, any value “v” associated with a terrain element may, in examples, be represented as v(i,j) wherein i and j are used as indexes to identify which terrain element of the grid the value v is associated with.

In examples of operation, a configuration manager 250 of pipeline design assistant 230 may determine the locations of the starting and destination points using information comprised within user configuration input 261. Configuration manager 250 may subsequently define a portion of terrain over which a cost-function surface is to be modelled. The portion of terrain may for example correspond to the entirety of the square area of terrain shown in FIG. 4A.

Configuration manager 250 may subsequently cause first information 251 (comprising topological elevation data) to be obtained from information source 150a and to be stored within server 106 in information storage 210a. Configuration manager may retrieve the first information and pass it to cost-function manager 260, or alternatively may configure cost-function manager 260 to obtain the first information 251 directly from information storage 210a.

Configuration manager 250 may further cause second information 252 related to the area of terrain to be obtained from one or more public or private information sources (such as information source 150b) and to be stored by server 106 within information storage 210b. Such second information 252 may comprise, for example, the known locations of roads, terrain features or obstacles, designations of land ownership, land use, terrain type and information concerning rights of way or paths of permitted access that are currently in force (in addition to any future expiration of such access permissions). Configuration manager 250 may retrieve the second information and pass it to cost-function manager 260 or alternatively may configure cost-function manager 260 to obtain the second information 252 directly from information storage 210b.

Configuration manager 250 may additionally cause third information 253 to be obtained, for example from information source 150c, and for this to be stored by server 106 within information storage 210c. Such third information 253 may for example comprise a maximum pipe pressure rating for a pipe product specified by a user 190 within user configuration input 261. In examples, the maximum pipe pressure corresponding to the user-specified pipe product may be determined by server 106 using product data held on information source 150c and made publicly available by the pipe's manufacturer via an internet connection over a network 104. Configuration manager 250 may retrieve the third information and pass it to pump determination manager 275 or alternatively may configure pump determination manager 275 to obtain the third information 253 directly from information storage 210c.

In examples, such third information 253 may for example comprise existing routes for the vehicular transportation and the fluid volumes and flow rates associated with those routes. In examples, third information 253 comprising existing routes may include, for example, any type of route information of fluid-bearing vehicles, e.g., trucks carrying water, crude, or other fluids. Route information may include data about routes, e.g., starting and ending points, roads taken, miles driven, fuel used, frequency of use, amounts and types of fluid transported over the route, types of vehicles used on the route, differential between road miles and aerial miles between a starting and ending point, and any other pertinent information.

In examples, routes for the vehicular transportation of fluids may be determined by server 106 using public or private data held on or supplied to information source 150c. In examples, the data relating to routes for vehicular transportation of fluids may be determined from the tracking, for example by the use of GPS, mobile tracking, WiFi tracking, cellular tracking, etc., of vehicles transporting water, oil or other fluids. In further examples, data relating to existing routes may further include route information from a mobile device associated with a fluid bearing vehicle, a driver of a fluid bearing vehicle, or an owner or manager of a fluid bearing vehicle. For example, in addition to tracking information, a user (e.g., driver, owner, operator, manager) may manually enter information about starting and ending points, fluid types and amounts transported, types of vehicles used, etc.

In examples, the data relating to existing routes for vehicular transportation of fluids may be determined by analysis of regulatory data. For example, public regulatory data, such as P-18 Skim Oil/Condensate reports, may be employed to map which production sources, e.g., producing leases, send water and skim oil to which disposal destinations, e.g., commercial disposals, and in what volumes each month. The pipeline design assistant 230 may further determine whether the fluid flows between producing leases and commercial disposals are transported by vehicle or pipeline. In embodiments, the pipeline design assistant 230 may compare determined fluid flows with the presence or absence of pipelines to determine how such flows are transported. In examples, regulatory data is made publicly available by public agencies via an internet connection over a network 104.

In accordance with the present example, configuration manager 250 may process administrator configuration input 271 to determine the following set of cost-function weights or parameters and to provide these to cost-function manager 260:

TABLE 3
Example Cost-Function Weight Parameters

| Cost-function | | |
|---|---|---|
| weight or | | Example |
| parameter | Description | value |
| w₁ | A cost-function weight associated with the | 40 |
| | presence or crossing of a road | |
| w₂ | A cost-function weight or parameter | −25 |
| | associated with an ease of access, such | |
| | as a distance to the nearest road | |
| w₃ | A cost-function weight associated with the | 30 |
| | presence or crossing of privately-owned land | |
| w₄ | A cost-function weight associated with the | 0 |
| | presence or crossing of public land | |
| w₅ | A cost-function weight associated with terrain | 1 |
| | elevation | |
| w₆ | A cost-function weight associated with an | −30 |
| | in-force right-of-way (RoW) or access permit | |
| K_{const} | A constant value or offset | 15 |

In addition to such cost-function weight inputs, cost-function manager 260 may also be provided with (or otherwise derive) a number of cost-function data inputs such as the topological elevation data of the first information 251 and the road location data, ease of access data, land-ownership data and right-of-way data of the second information 252. Such data inputs may be represented as a value dₙ(i,j) associated with each terrain element. For illustrative purposes, table 4 lists the data inputs that may be associated with the present example though it shall be appreciated that a multitude of other cost-function data inputs may be derived based upon the ensemble of inputs provided to pipeline design assistant 230:

TABLE 4
Example Cost-Function Data Inputs

| Cost-function | | |
|---|---|---|
| data input | Description | Example value |
| d₁(i, j) | An indicator of road presence for terrain | 0 (not present) |
| | element (i, j) | 1 (present) |
| d₂(i, j) | A distance to a nearest road for terrain | Distance in meters |
| | element (i, j) | |
| d₃(i, j) | An indicator of private land ownership | 0 (not private land) |
| | for terrain element (i, j) | 1 (private land) |
| d₄(i, j) | An indicator of public land ownership | 0 (not public land) |
| | for terrain element (i, j) | 1 (public land) |
| d₅(i, j) | A terrain elevation | Meters above sea- |
| | | level |
| d₆(i, j) | An indicator of the presence of an | 0 (not present) |
| | in-force right-of way (RoW) or access | 1 (present) |
| | permit for terrain element (i, j) | |

In embodiments, cost function manager 260 may calculate a cost-function surface s(i,j) for example based upon the cost-function weights or parameters and the cost-function data inputs. With reference to the present example, cost-function manager 260 may in some embodiments, calculate cost-function surface s(i,j) as a weighted-sum of N=1 . . . n product terms (wₙ·dₙ(i,j)) plus a constant K_{const}. One example calculation for s(i,j) may be:

s(i,j)=w₁d₁(i, j)+w₂d₂(i, j)+w₃d₃(i, j)+w₄d₄(i, j)+w₅d₅(i, j)+w₆d₆(i, j)+K_{const}

In general however, the cost-function surface s(i,j) may be any linear or non-linear function of the cost-function inputs, may or may not use cost-function weights such as those previously described and may use any other or additional parameters as deemed appropriate or effective. Further, cost-function surface “s” need not conform to the abovementioned (i,j) indexing (as used for the regular 2D-grid representation of the terrain surface of FIG. 4A) and may more-generally represent one or more costs each associated with a respective geographical point within the terrain, whether regularly spaced or not. Alternatively, cost-function “s” may represent one or more costs each associated with a cost between a pair of geographical points. Thus, the terrain surface and/or the cost-function surface may be represented or otherwise sub-divided into a regular grid, an irregular grid, or a sparse or abstract set of values each associated with a geographical point or an interconnection between geographical points.

By using different cost-function weight parameters and/or different cost-function data inputs, different cost-function surfaces s(i,j) may be calculated by cost-function manager 260.

In embodiments, cost function manager 260 may store one or more cost-function surfaces, for example in cost-function storage 220 such that they are available for further processing within pipeline design assistant 230, for example, by pipeline route determination manager 270.

Pipeline route determination manager 270 may process any information received by it in order to determine one or more pipeline routes that aim to meet the requirements and optimization criteria specified by the user 190, subscriber 195 or administrator 197 of online platform 180. In examples, pipeline route determination manager 270 may receive a cost-function surface from cost-function manager 260 or from cost-function storage 220.

Pipeline route determination manager 270 may process a cost function surface such as s(i,j) in accordance with any configuration information received from configuration manager 250 in order to determine one or more pipeline routes that best-meet the criteria provided in user configuration input 261 and/or administrator configuration input 271.

In order to determine a preferred route, pipeline route determination manager 270 may use a route-finding (or path-finding) algorithm. Such path-finding algorithms may perform an exhaustive search for an optimized path, though this may be computationally expensive. Alternatively, a non-exhaustive path-finding algorithm may be used to find a good path with reduced computational complexity. In general, path-finding algorithms may be based on graph theory in which a collection of “nodes” (or vertices, or points) are interconnected by “edges”. An edge connection between two nodes (for example node A and node B) may be associated with a value or cost. In an illustrative road-network example, this cost may be a distance between cities A and B or a level of traffic congestion between A and B, whereas in the context of pipeline route optimization, a cost at or between nodes representing the terrain surface may be derived for example using a cost-function surface s(i,j) such as previously described. The objective of the path-finding algorithm is to find paths that have a low overall or total mathematical cost along their length. Such a total mathematical cost may, in some examples, be calculated as a sum of contributory costs, such as a sum of the cost at all visited nodes, or a sum of all edges that interconnect the nodes along the path.

FIG. 4B illustrates one example of a simple graph comprising 5 nodes denoted Q₁, Q₂, Q₃, Q₄ and Q₅ that are connected in the example via 7 edges. Each edge may be denoted E_{x,y} where x and y represent the pair of interconnected nodes. In the example graph of FIG. 4B, the 7 edges are: E_{1,3}=2, E_{1,2}=4, E_{2,3}=7, E_{2,5}=5, E_{3,4}=1, E_{3,5}=8 and E_{4,5}=2. The least-cost path between nodes Q₁ and Q₅ would then route through nodes Q₁→Q₃→Q₄→Q₅, with a total cost of E_{1,3}+E_{3,4}+E_{4,5}=5. All other routes have higher total cost.

In the context of a pipeline routing application, cost-function manager 260 or pipeline route determination manager 270 may determine one or more edge values using the cost-function input data that is used to represent the terrain and may further utilize such edge values when determining a preferred pipeline route. FIG. 4C illustrates one example in which edge values 460 are computed as a difference between terrain element values 450 (e.g. any of h₀, h₁, h₂, . . . h₈). The terrain element values 450 may for example be contained within a data input array such as d₅(ij) denoting absolute elevation (e.g. height above sea level) for a plurality of respective terrain elements 470. Edge values 460 representing for example, a difference in elevation, may be computed using the information contained within the array d₅(i,j) and these may be subsequently used to determine either a cost function surface or used within a path-finding algorithm to determine a preferred pipeline route. In an alternative embodiment, an array of elevation values (such as d₅(i,j)) may instead be converted, for example via a process of mathematical differentiation, into a corresponding array d_{5′}(i,j) representative of the directional gradient of the terrain at each terrain element 470. The differentiated array (such as d_{5′}(i,j) may then be used to determine a cost-function surface or used as an input to a path-finding algorithm. Such principles apply not only to elevation data, but to any of the terrain-related data inputs to cost function manager 260. It shall be appreciated therefore that cost-function manager 260 or pipeline route determination manager 270 may use data input values directly, or may derive and use differentiated values, or edge values when determining a cost function surface or when determining a preferred route using a path-finding algorithm.

In certain path-finding algorithms, reduced complexity approaches may be employed in which different strategies are used to iteratively and systematically explore the nodes of the graph in a particular order. Such a guided search is often referred to as a “tree search”. Examples of guided tree searches include “Dijkstra's” Shortest-Path-First (SPF) algorithm (attributable to computer scientist Edsger W. Dijkstra), a “Breadth-First Search”, a “Best-First Search” a “Uniform Cost Search”, a “Depth-First Search”, a “Depth-Limited Search” (DLS) and an “Iterative Deepening Search (IDS)”. Modifications of Dijkstra's algorithm may also be used, such as the “A*” algorithm attributable to Peter Hart, Nils Nilsson, and Bertram Raphael of Stanford Research Institute.

In general, any suitable path-finding or route-finding algorithm may be used by Pipeline Route Determination Manager 270. In examples, Configuration Manager 250 may instruct Pipeline Route Determination Manager 270 to utilize a particular algorithm or may configure Pipeline Route Determination Manager 270 with one or more algorithm parameters that govern its mode of operation.

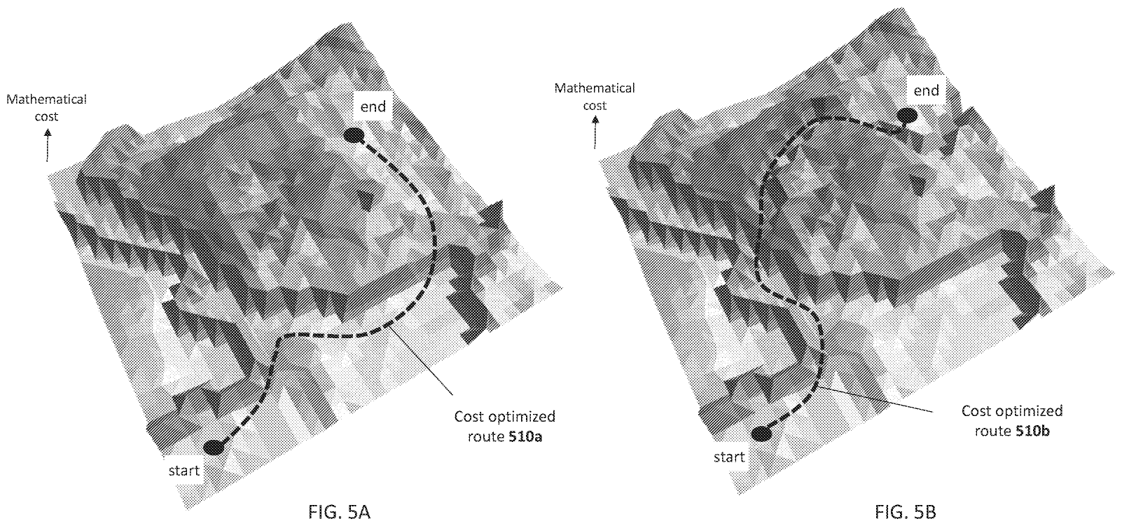

By means of illustration, FIG. 5A shows a first example cost-function surface s(i,j). The higher costs associated with a pipeline crossing a road can be seen, as can the general effects of elevation and the private land-ownership designation of some portions of the terrain (observe the raised central portion of the cost-function surface). In the example of FIG. 5A, the cost mitigation afforded by w6=-30 and the presence of the right-of way indicated by d₆(i,j)=1 is not taken into account. Such a situation may arise for example if a user of the system stipulates in user configuration input 261 that a planned lifetime of the pipeline is two years but in processing second information 252, configuration manager 250 determines that the identified right-of-way expires in one year's time, hence cannot be relied upon for the expected lifetime of the pipeline. Configuration manager 250 may therefore cause cost-function manager to use a cost-function weight w₆=0 or to remove the presence of the right-of-way by setting appropriate elements of cost-function data input d₆(i,j)=0. As a result, pipeline route determination manager 270 may subsequently identify a first cost-optimized route 510a that takes a route predominantly following a low-elevation path and which also minimizes the amount of privately-owned land that must still necessarily be crossed (for which a permit would need to be sought for the full term of the pipeline).

In contrast, FIG. 5B shows a second example cost-function surface s(i,j) in which the cost mitigation afforded by w₆=−30 and the presence of the right-of way indicated by d₆(i,j) is taken into account. Such a situation may arise for example if the user configuration input 261 stipulates that the planned lifetime of the pipeline is nine months (as opposed to two years in the prior example) and is therefore within the one-year expiry time of the present right-of-way permit. As a result, pipeline route determination manager 270 may subsequently identify a second cost-optimized route 510b that utilizes the right-of-way. Even though this takes the pipeline over higher elevations than route 510a, route 510b requires no new permit application.

One or more pipeline routes determined by pipeline route determination manager 270 may be passed to route storage 222 or to pump determination manager 275. Using such route information, pump determination manager 275 may determine a placement, size, type or other technical attribute of one or more fluid pumps along the pipeline route. In doing so, pump determination manager 275 may take into account both technical requirements and non-technical factors. For example, from a technical perspective, pump determination manager 275 may first determine a maximum permissible elevation gain between any two consecutive pump locations, based on one or more of; a fluid density or viscosity, a flow rate, a maximum pipe pressure, a maximum pressure rating of available pumps or a maximum pressure rating of a product model specified by user 190. Pump determination manager 275 may then determine a minimum set of candidate pump locations using an elevation profile of the pipeline route, such that the maximum permissible elevation gain is not exceeded at any point. More generally, in addition to the elevation data in first information 251, pump determination manager 275 may take into account any technical or performance-related requirements derived from user configuration input 261, or any technical fluid pump data, technical pipe data or in-the-field technical performance data derived from third information 253. Examples of such technical requirements and technical data are listed in Table 1.

From a non-technical perspective, pump determination manager 275 may also attempt to identify fluid pump locations having for example, a particular terrain type, a particular land use or an improved ease of access. In other examples, pump determination manager 275 may attempt to identify pump locations for which a financial cost associated with installation or maintenance is reduced, or which are geographically close to a location of pump equipment, materials or resources. More generally, pump determination manager 275 may take into account any non-technical related information derived from user configuration input 261, second information 252 or third information 253. In yet further examples, pump determination manager 275 may also take into account cost-function-related information from cost-function manager 260 or from configuration manager 250. Examples of such non-technical information are listed in Table 1.

In addition to determining fluid pump locations, pump determination manager 275 may, in some examples, determine fluid pump requirements, pipe requirements, or technical and performance data concerning a candidate pipeline route or a pump. Some examples of fluid pump requirements, pipe requirements and technical/performance data are provided in Table 2.

Whilst the above describes an example of the operation of pump determination manager 275 using one or more candidate pipeline routes supplied by pipeline route determination manager 270, system 200 may also operate such that the location and design (size, type or other technical attribute) of one or more fluid pumps is determined during the operation of pipeline route determination manager 270 itself. That is, pipeline route determination manager 270 may take into account the technical and non-technical factors that affect pump placement in order to select the one or more candidate pipeline routes in the first instance. In general, the pipeline route and the location and design of the pumps may be jointly determined and optimized. Alternatively, the pipeline route may initially be determined in a first stage, and the location and design of the pumps may then be determined in a later second stage. As a further alternative, the location and design of the pumps may initially be determined in a first stage, and a pipeline route (routing via the determined pump locations) may be then be derived.

Pump determination manager 275 (or pipeline route determination manager 270) may store information regarding selected or proposed pump locations and/or the specification or design of pumps along a candidate route in pump storage 224. Alternatively, pump determination manager 275 (or pipeline route determination manager 270) may transfer such information directly to user interaction manager 280 for onward processing and conveyance to a user 190 or subscriber 195 of online platform 180.

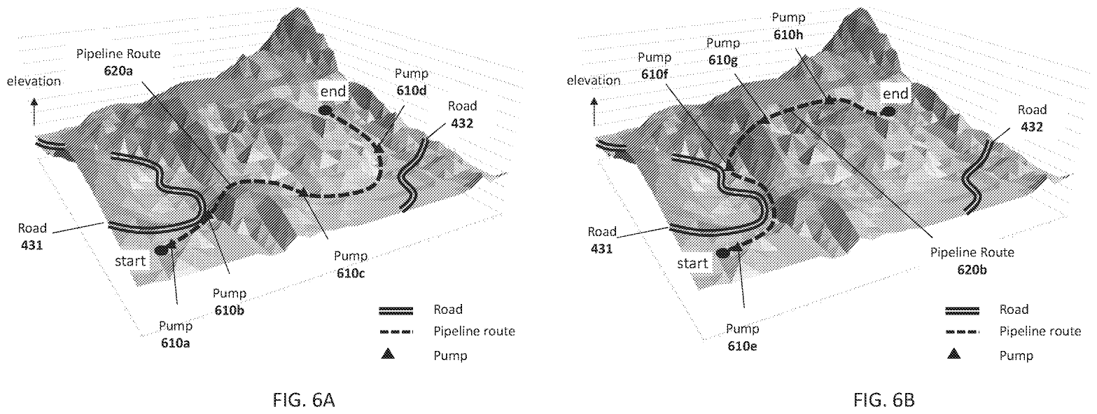

FIG. 6A illustrates pump locations 610a, 610b, 610c and 610d as may be determined by pump determination manager 275 according to some examples. The surface plotted in FIG. 6A represents terrain elevation, and the pumps are located along a candidate pipeline route 620a (such as cost-optimized route 510a in FIG. 5A) as may be determined by pipeline route determination manager 270. Pump 610a is located at the start location. Pump 610b is strategically located close to road 431 giving ease-of-access for installation and maintenance, whilst also providing sufficient pressure to overcome the elevation gain between itself and pump 610c. Pumps 610c and 610d are also strategically located such that they are not within the area of private land as designated 410 in FIG. 4A.

FIG. 6B illustrates an alternate set of pump locations 610e, 610f, 610g, and 610h as may be determined by pump determination manager 275 according to some examples. As for FIG. 6A, the surface plotted in FIG. 6B again represents terrain elevation, and the pumps are this time located along candidate pipeline route 620b (such as cost-optimized route 510b in FIG. 5B) as may be determined by pipeline route determination manager 270. Pump 610e is located at the start location. Advantageously, the first 40% of the route (to pump 610f) runs alongside road 431 providing good access for pipeline installation and maintenance. Pump 610f is the first of three pumps (610f, 610g and 610h) specified and designed to overcome the elevation gain from pump 610f to the end destination. Whilst pumps 610g and 610h are located on private land and are remote from any road, they are necessary to achieve the technical requirements of the pipeline and are at least located along an in-force right-of-way (such as right-of-way 420 in FIG. 4A) such that some access for maintenance remains possible.

In examples, user interaction manager 280 of pipeline design assistant 230 may be configured to return information regarding one or more candidate pipeline routes (“pipeline route information”), and the associated pump locations and pump specifications or pump design plans (“pump information”) to a user 190 or subscriber 195 of online platform 180. More generally, user interaction manager 280 may be configured to provide any component of pipeline design output information 285, for example to a user 190 or subscriber 195 of online platform 180. Some examples of information content that may be comprised within pipeline design output information 285 are given in Table 2.

User interaction manager 280 may process the pipeline route information and pump information in order to facilitate its graphical or textual display. In examples, this may include one or more of:

formatting the information into a document or report for download by the user

processing or creating images of the terrain

processing or creating images of terrain features or terrain obstacles that may be graphically overlaid on images of the terrain

processing or creating images of a candidate pipeline route or of pump locations that may be graphically overlaid on images of the terrain

processing or creating images representing technical or performance data (for example, an internal pipe pressure associated with a pipeline or pumps along a candidate pipeline route) and which may be graphically overlaid on images of the terrain

User interaction manager 280 may also facilitate dynamic user interaction with pipeline design assistant 230 in order that the user may retrieve additional detail regarding the terrain, a candidate pipeline route or a pump. In examples, such additional detail may be derived from elevation data comprised within first information 251, from auxiliary terrain-related data comprised within second information 252, from non-terrain-related information comprised within third information 253 or from any component of pipeline design output information 285.

In examples, the dynamic user interaction may be facilitated by user interaction manager 280, for example, by providing interactive links or “clickable” areas of an image or graphical display that a user may select to retrieve the additional detail.

In further examples, user interaction manager 280 may also facilitate dynamic user interaction with pipeline design assistant 230 in order that the user may:

provide or modify (for example via a graphical user interface) a user configuration such as user configuration input 261;

adjust, select or define a candidate route (for example, by dragging a displayed route such that the route is altered to pass through different geographical locations) or;

adjust, select or define a pump location (for example, by dragging a displayed pump to a new geographical location).

In examples, subsequent to changing a user configuration input parameter, a candidate pipeline route or a pump location, pipeline deign assistant 230 may update or recalculate pipeline design output information 285 using the methods and embodiments that have been previously described within this disclosure.

In examples, user interaction manager 280 may also determine financial costs associated with a candidate pipeline route or the selected pump equipment. The financial costs may be derived and presented to a user for each of a number of constituent or component costs, or an aggregate or total cost may instead be provided. The financial costs may be associated with an installation of the pipeline, with operations and maintenance of the pipeline or with deinstallation of the pipeline. In examples, these pipeline financial costs may arise due to man-power requirements (labor), equipment (such as pumps and pipes), fuel and energy (such as gas for trucks and generators, or electrical running costs for pumps), or supplies or resources (such as concrete for pipe or pump ground anchors, vehicles for earth-moving equipment and general transport).

In examples, user interaction manager 280 may determine financial costs associated with a candidate pipeline route or the selected pump equipment and compare these with the costs for the vehicular transportation of fluids. The vehicular financial costs for the vehicular transportation of liquids may be derived and presented to a user for one or more fluid bearing vehicle routes. In examples, these costs may arise due to man-power requirements (labor, including drivers), equipment (such as trucks and other vehicles), maintenance of equipment, fuel and instillations (for example for the collection and disposal of fluids). In examples, user interaction manager 280 may identify the time period for which the pipeline will operate from user configuration input 261. In examples, user interaction manager 280, may determine the depreciation, cost of capital and amortization across the time period for which the pipeline will operate.

In examples, the user interaction manager 280 may compare the financial costs associated with a candidate pipeline route and a vehicular route with the same starting and ending locations to determine the economic advantage or viability of pipeline construction. In further examples, the user interaction manager 280 may compare the financial costs associated with many candidate pipeline routes and corresponding vehicular routes. Accordingly, based on such multiple cost comparisons, the user interaction manager 280 may be configured to identify pipeline starting and ending locations that provide the most economic value, e.g., cost savings. Such starting and ending locations may, for example, define routes where a direct pipeline would reduce the most road miles (i.e., the road path is indirect and long but the pipe path could be short and direct) for pickup and delivery of fluids. Road miles for a given route may be weighted by an amount of fluid transported over the route when making such a calculation. As discussed above, when performing cost comparisons, the user interaction manager 280 is configured to account for present and future costs of vehicular and pipeline transport. For example, the initial costs of pipeline construction, as discussed throughout, may be viewed according to various metrics, such as depreciation, amortization, cost of capital, etc. plus pipeline operating costs, so as to be compared with the ongoing and predicted costs of vehicular transport.

In other examples, user interaction manager 280 may determine one or more project timescales, for example, an estimate of time required to complete the installation or deinstallation of a pipeline along a candidate pipeline route.

In further examples, user interaction manager 280 may determine a ranking or score of a selected or candidate pipeline route, for example such that this may be displayed to a user to facilitate a comparison of different candidate routes. The ranking or score may be based on the degree to which the user's criteria and requirements (for example as specified by the user in user configuration input 261) have been satisfied or met. Alternatively, the ranking or score may be based on a total mathematical routing cost of a candidate route over a cost function surface (such as cost-function surface s(i,j)), a financial cost of a candidate pipeline route, a technical performance metric associated with a candidate pipeline route or pumps, a cumulative elevation gain, or a number of fluid pumps. In general, user 190 or subscriber 195 may specify the optimization or ranking criteria in configuration input 260, or default criteria may instead be used (for example, as configured by administrator 197 in administrator configuration input 271). The default or user-specified optimization or ranking criteria may subsequently be used by user interaction manager 280 to determine the ranking or score of candidate pipeline routes to user 190.

The pipeline design output information 285 returned by pipeline design assistant 230 may be used by a user 190 or subscriber 195 of online platform 180 to set in motion a physical realization and construction of the pipeline. This may involve initiating work with multiple contracting parties to achieve the aims of the project. During field work, such contracting parties may encounter situations on the ground that were not taken into account during the pipeline planning phase. For example, the presence of a new terrain feature or obstacle may be identified that was not previously known, or a terrain type may be identified as being wrongly captured in the input information that was originally provided to the system. In other examples, more accurate elevation data may be obtained as a result of field visits. In further examples, measurements of pipeline performance or other technical data may be taken or manually recorded by field workers or may be measured by in-the-field sensors such as pressure, temperature or flowrate sensors which may be installed within the pipeline infrastructure. Such measurements may also be stored in one or more memories or storages to which the sensor equipment is connected. In examples, stored measurements may either be retrieved by field workers (e.g. via the connection of a laptop computer to transfer the recorded data), or in the case that the field sensors are network-connected (e.g. via a network 104), may be communicated, either in real-time or bulk fashion, to any suitable remote station or server (such as online platform 180 or server 106) for further processing. Accordingly, in embodiments, system 200 may further be configured to accept terrain update inputs, or pipeline technical and performance data inputs from field crews working on the project or from field sensors and sensor networks, such that over time, the system continually adapts to and accounts for the latest known information. This may be used to correct a pipeline design or to improve the accuracy of information used to facilitate future pipeline designs. In further examples, the updated information may also be used to adjust or tune a pipeline once installed. For instance, if a flowrate of an installed pipeline is lower than expected, the pump speeds may then be adjusted to meet the designed flowrate target. System 200 may facilitate this return of updated “in-the-field” data via suitable sensor or communication networks, via a graphical user interface presented on a user device such as a smartphone, tablet or laptop, or may be configured to accept and parse text-based inputs (such as email) or voice-based inputs (such as voicemail) from the field crews. System 200 may also be configured to feed back the received updates to the original information sources (such as information sources 150a-c) in order that they are also continually maintained to store the latest available information.

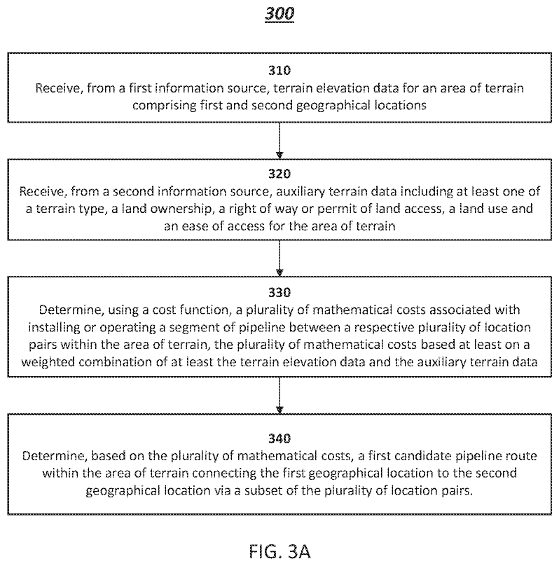

FIG. 3A illustrates a method 300, according to some embodiments, for determining a route for a pipeline conveying a fluid from a first geographical location (e.g. a starting point) to a second geographical location (e.g. an ending, or destination point) via at least one fluid pump. In step 310, the method includes receiving from a first information source (such as information source 150a), terrain elevation data for an area of terrain that spans or otherwise includes both the first and second geographical locations. The terrain elevation data may be in any suitable format and may comprise for example a plurality of terrain heights above mean sea level at each of a respective plurality of geographical coordinate locations (such as may be represented by a longitude and latitude coordinate pair). In step 320, the method further includes receiving from a second information source (such as information source 150b), auxiliary terrain data that includes at least one of a terrain type, a land ownership, a right of way or permit of land access, a land use and an ease of access for the area of terrain. Thus, the auxiliary terrain data comprises additional information (beyond the elevation data) regarding the terrain. Table 1 lists (under second information 252) further details and examples of auxiliary terrain data that may be included in the information from the second information source. In step 330, the method includes determining, using a cost function, a plurality of mathematical costs associated with installing or operating a segment of pipeline between a respective plurality of location pairs within the area of terrain, the plurality of mathematical costs based at least on a weighted combination of at least the terrain elevation data and the auxiliary terrain data. The cost function used to determine the mathematical cost associated with a segment of pipeline between location pairs may include a summation of product terms, each product term comprising a multiplication of a weighting factor “wₙ” with a data input “dₙ”. The weighting factor may be associated with a particular attribute of interest regarding the nature of the terrain over which the segment of pipeline passes. Table 3 lists some examples of different cost-function weighting factors “wₙ” whilst Table 4 lists some examples of different cost-function data inputs “dₙ”. In some examples, the method may use the terrain elevation data directly as one of the data inputs to the cost function. In other examples, the method may include processing the elevation data prior to its use within the cost function. Such processing of the elevation data may include differentiating the elevation data to provide a directional terrain gradient or may include normalizing the elevation data or calculating a terrain elevation difference between locations. In step 340, the method further includes determining, based on the plurality of mathematical costs, a first candidate pipeline route within the area of terrain connecting the first geographical location to the second geographical location via a subset of the plurality of location pairs. Step 340 may include applying a path-finding algorithm to the plurality of mathematical costs in order to identify a preferred candidate pipeline route exhibiting a minimum or generally-low-cost overall (or total) mathematical cost. The total mathematical cost associated with the first candidate pipeline route may be determined as a sum of the plurality of mathematical costs associated with nodes along its length and/or with edges that interconnect the nodes along its length. Whilst not explicitly shown in FIG. 3A, method 300 may also include receiving further information including at least one of technical fluid pump data and technical pipe data and determining one or more pump locations along the first candidate pipeline route based on the terrain elevation data and the at least one of technical fluid pump data and technical pipe data. In further examples, method 300 may also include determining a technical performance attribute associated with a pipeline (for example, an internal pipe pressure) if routed in accordance with the first candidate pipeline route and displaying the technical performance attribute to a user of an online platform. In yet further examples, method 300 may include receiving additional information including at least one of labor costs, fuel and energy costs, and materials costs. The method may then include determining a first financial cost associated with installation, deinstallation, operation or maintenance of a pipeline if routed in accordance with the first candidate pipeline route and displaying the first financial cost to a user of an online platform.

The foregoing has described examples of how system 200 and its constituent components may be configured to operate in accordance with a variety of alternative embodiments. In general, embodiments may use all or only a subset of the components and functionality of system 200. In one example of a simplified embodiment, a user 190 of online platform 180 may specify (for example in user configuration input 261) a particular pipeline route from a starting location to a destination location, thereby obviating any need for pipeline route determination manager 270 to identify a preferred or candidate route. However, other components of system 200 may still be employed in such an embodiment. For example, pump determination manager 275 may still be used to determine the location and/or the technical specification of fluid pumps along the user-specified route, optionally also in accordance with other information contained within user configuration input 261 (such as the technical or performance-related requirements listed in Table 1). Pipeline design assistant 230 may then return to the user 190, the corresponding pump design and location information within pipeline design output information 285 in the same manner as has been previously described.

While the foregoing describes a particular set of techniques for determining a route for a pipeline and the location and specification of fluid pumps along its length, it will be understood that the information thereby obtained may be usefully employed by a variety of interested parties including oilfield operators, suppliers of oilfield resources, equipment or services, and financial analysts or financial institutions.

The above systems, devices, methods, processes, and the like may be realized in hardware, software, or any suitable combination of these. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof and may be distributed across devices in several ways. At the same time, processing may be distributed across devices such as the various systems described above, or all the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity and need not be located within a particular jurisdiction.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the disclosure as defined by the following claims, which are to be interpreted in the broadest sense allowable by law.

1.-22. (canceled)

23. A computer-implemented method for generating a dynamic graphical user interface for pipeline design to be carried out by at least one processor executing computer instructions, the method including:
displaying, within a graphical user interface provided via a user display device, an area of terrain and associated terrain elevation data;
receiving, from a user via the graphical user interface, a first geographical location within the area of terrain;
receiving, from the user via the graphical user interface, a second geographical location within the area of terrain;
displaying, via the graphical user interface, a candidate pipeline route between the first geographical location and the second geographical location as an overlay on the area of terrain;
displaying, via the graphical user interface, candidate pump locations along the candidate pipeline route;
receiving, from the user via the graphical user interface, an adjustment to at least one of the candidate pipeline route and the candidate pump locations; and
displaying an updated candidate pipeline route and updated candidate pump locations generated according to the adjustment.

24. The computer-implemented method of claim 23, further comprising:
tracking a plurality of fluid bearing vehicles by at least one of GPS, mobile tracking, WiFi tracking, and cellular tracking;
identifying a vehicle route of fluid-bearing vehicles across the area of terrain according to the tracking; and
displaying the vehicle route via the graphical user interface.

25. The computer-implemented method of claim 24, further comprising receiving a user selection of locations on the vehicle route as the first geographical location and the second geographical location.

26. The computer-implemented method of claim 24, further comprising displaying a comparison of parameters associated with the vehicle route, the candidate pipeline route, and the updated candidate pipeline route.

27. The computer-implemented method of claim 23, further comprising:
receiving auxiliary terrain data including at least one of a terrain type, a land ownership, a right of way or permit of land access, a land use and an ease of access for the area of terrain; and
displaying, via the graphical user interface, the auxiliary terrain data.

28. The computer-implemented method of claim 27, further comprising determining the candidate pipeline route and the candidate pump locations according to the terrain elevation data and the auxiliary terrain data.

29. The computer-implemented method of claim 27, further comprising:
receiving in-the-field information, the in-the-field information comprising information obtained from field locations associated with the candidate pipeline route that updates one or more of the terrain elevation data and the auxiliary terrain data and
generating the updated candidate pipeline route according to the in-the-field information.

30. The computer-implemented method of claim 27, further comprising:
modeling the area of terrain as a plurality of mesh grid squares, each mesh grid square associated with values of the terrain elevation data and values of the auxiliary terrain data;
determining a function surface according to the values of the terrain elevation data and the values of the auxiliary terrain data associated with the mesh grid squares, the function surface determined according to a weighted combination of the values of the terrain elevation data and the values of the auxiliary terrain data;
determining, according to the function surface, a plurality of parameters associated with installing or operating a segment of pipeline between a respective plurality of location pairs within the area of terrain; and
determining a subset of the plurality of location pairs between the first geographical location and the second geographical location to form the candidate pipeline route based on the respective plurality of parameters.

31. The computer-implemented method of claim 30, further comprising:
identifying the candidate pump locations along the first candidate pipeline route based on the terrain elevation data and the auxiliary terrain data.

32. The computer-implemented method of claim 23, further comprising receiving, via the graphical user interface, the adjustment according to a user operation within the graphical user interface that drags at least a portion of the candidate pipeline route or the candidate pump locations to a new geographical location.

33. An interactive user system for generating a dynamic graphical user interface for pipeline design to be displayed via a user display device and permit input via a user input device, the system comprising:
a computer memory storing instructions; and
a processor configured to execute the instructions for:
displaying, within a graphical user interface provided via the user display device, an area of terrain and associated terrain elevation data;
receiving, from a user via the graphical user interface, a first geographical location within the area of terrain;
receiving, from the user via the graphical user interface, a second geographical location within the area of terrain;
displaying, via the graphical user interface, a candidate pipeline route between the first geographical location and the second geographical location as an overlay on the area of terrain;
displaying, via the graphical user interface, candidate pump locations along the candidate pipeline route;
receiving, from the user via the graphical user interface, an adjustment to at least one of the candidate pipeline route and the candidate pump locations; and
displaying an updated candidate pipeline route and updated candidate pump locations generated according to the adjustment.

34. The system of claim 33, wherein the processor is further configured for:
tracking a plurality of fluid bearing vehicles by at least one of GPS, mobile tracking, WiFi tracking, and cellular tracking;
identifying a vehicle route of fluid-bearing vehicles across the area of terrain according to the tracking; and
displaying the vehicle route via the graphical user interface.

35. The system of claim 34, wherein the processor is further configured for receiving a user selection of locations on the vehicle route as the first geographical location and the second geographical location.

36. The system of claim 34, wherein the processor is further configured for displaying a comparison of parameters associated with the vehicle route, the candidate pipeline route, and the updated candidate pipeline route.

37. The system of claim 33, wherein the processor is further configured for:
receiving auxiliary terrain data including at least one of a terrain type, a land ownership, a right of way or permit of land access, a land use and an ease of access for the area of terrain; and
displaying, via the graphical user interface, the auxiliary terrain data.

38. The system of claim 37, wherein the processor is further configured for determining the candidate pipeline route and the candidate pump locations according to the terrain elevation data and the auxiliary terrain data.

39. The system of claim 37, wherein the processor is further configured for:
receiving in-the-field information, the in-the-field information comprising information obtained from field locations associated with the candidate pipeline route that updates one or more of the terrain elevation data and the auxiliary terrain data and
generating the updated candidate pipeline route according to the in-the-field information.

40. The system of claim 37, wherein the processor is further configured for:
modeling the area of terrain as a plurality of mesh grid squares, each mesh grid square associated with values of the terrain elevation data and values of the auxiliary terrain data;
determining a function surface according to the values of the terrain elevation data and the values of the auxiliary terrain data associated with the mesh grid squares, the function surface determined according to a weighted combination of the values of the terrain elevation data and the values of the auxiliary terrain data;
determining, according to the function surface, a plurality of parameters associated with installing or operating a segment of pipeline between a respective plurality of location pairs within the area of terrain; and
determining a subset of the plurality of location pairs between the first geographical location and the second geographical location to form the candidate pipeline route based on the respective plurality of parameters.

41. The system of claim 40, wherein the processor is further configured for identifying the candidate pump locations along the first candidate pipeline route based on the terrain elevation data and the auxiliary terrain data.

42. The system of claim 34, wherein the processor is further configured for receiving, via the graphical user interface, the adjustment according to a user operation within the graphical user interface that drags at least a portion of the candidate pipeline route or the candidate pump locations to a new geographical location.
